(19) United States
(12) Patent Application Publication
(10) Pub. No.: US 2009/0115614 A1
(43) Pub. Date: May 7, 2009

(54) AUTHENTICATION OF AN ELECTRONIC TAG DURING ACCESS TO A SERVICE, ASSOCIATED METHODS AND SYSTEM

(75) Inventors: Marc Bertin, La Celle Les Bordes (FR); Aurelie Barbotin, Rennes (FR)

Correspondence Address: YOUNG & THOMPSON, 209 Madison Street, Suite 500, ALEXANDRIA, VA, 22314, US

(73) Assignee: OBERTHUR TECHNOLOGIES, Paris (FR)

(21) Appl. No.: 12/261,284

(22) Filed: Oct. 30, 2008

(30) Foreign Application Priority Data
Oct. 30, 2007 (FR) 0758701

(51) Int. Cl. G08B 13/14

(52) U.S. Cl. 340/572.8

(57) ABSTRACT

A method of authentication during access to a service for providing intangible goods, includes:
obtaining, in an electronic tag, at least one authentication datum by cryptographic processing,
transmitting the at least one authentication datum obtained to an external item of equipment, the electronic tag and the external item of equipment being able to communicate with one another,
verifying the at least one authentication datum received by the external item of equipment.

The electronic tag is stuck onto a mobile telephone item of equipment so that the transmissions between the electronic tag and the external item of equipment require the presence of the mobile telephone item of equipment.

The present invention pertains generally to electronic tags and more particularly to authentication during access to a service with the aid of such a tag, to the access to this service and to the securing of such authentication.

Electronic tags are chiefly known in the form of radiofrequency identification tags, or RFIDs, comprising a microcircuit and short-range wireless communication means allowing the microcircuit to communicate with an exterior electronic entity.

The expression short-range wireless communication means implies communication means making it possible to perform a transaction by bringing the tag furnished with such means near to a dedicated electronic reader. In particular, short-range is understood to mean less than a meter.

Thus, proximity between the tag and the reader for performing a transaction makes it possible to guarantee the tag bearer's intention to carry out the transaction and to ensure transaction security.

RFID tags are found in numerous applications, for example for the tracing or stock-taking of products and objects.

The invention relates precisely to electronic tags implementing authentication mechanisms during access to a service. The term “service” is understood in the sense of any provision of intangible goods performed by an exterior entity, for example the transport of persons, a banking transaction (for example when purchasing a tangible product in a store), an information database, a show.

Electronic tags can in particular be associated, for example with a specific owner, to allow access to a service solely to the owner in possession of his tag. This association can, for example, be effected by registering a subscriber number tied to the service in question. The term “owner” means the individual who is granted the right to hold and/or to personally use the tag and the item of information which is stored in the latter, here the subscriber number. This right may in particular be conferred by the third party. In practice, subsequently the owner physically holds the electronic tag in order to be able to use, during transactions, the information that it contains.

As a consequence of the advances in miniaturization in the field of electronic tags, it is henceforth easy for a third party individual to be lent the electronic tag. Should this tag be associated with an owner, it could result in prejudicial consequences.

The present invention is thus aimed at combating identity spoofing during the use of these tags since this spoofing may in particular appear prejudicial in respect of a third party or the owner himself.

A requirement therefore exists to improve and to secure authentication on the basis of an electronic tag.

For this purpose, the invention is aimed in particular at a method of authentication during access to a service, the method comprising the following steps:
obtaining, in an electronic tag, at least one authentication datum by means of a cryptographic processing,
transmitting said at least one authentication datum obtained, from said electronic tag to an external item of equipment, the electronic tag and the external item of equipment being able to communicate with one another,
verifying said at least one authentication datum received by said external item of equipment,

in which method said electronic tag is stuck onto a mobile telephone item of equipment so that said transmissions between the electronic tag and the external item of equipment require the presence of said mobile telephone item of equipment.

Thus, the sticking bond formed between the mobile telephone item of equipment and the electronic tag increases the security when accessing complex electronic systems (implemented in respect of a service) requiring the use of the electronic tag. Specifically, the user naturally keeps his mobile telephone on him. An additional security pledge is thus obtained as compared with a situation where the electronic tag would not be tied to a personal and individual item of equipment.

It is noted here that the use of the tag by another individual is all the more difficult as the portable telephone chosen is considered to be personal by the possessor himself, the owner of the tag. The owner not wishing to separate himself from his portable telephone, the sticking then deters the latter from lending his electronic tag to a third party.

Furthermore, the mobile telephone is used as transport vector for the electronic tag, thereby making it possible to be satisfied with simple packaging of the electronic tag. The miniaturization of the electronic systems of this type is thus exploited in order to provide a compact and cheap electronic means of authentication.

Furthermore, the invention advantageously offers improved authentication by using particularly simple means.

Various cryptographic processings can be used in an alternate manner or in combination to improve the authentication, for example the DES (the acronym standing for “Data Encryption Standard”), AES (the acronym standing for “Advanced Encryption Standard”) and RSA (the acronym standing for “Rivest Shamir Adleman”) encryption-decryption mechanisms or the signature mechanisms of the “challenge response” type.

It is also noted that the authentication datum allowing access or otherwise to the service therefore corresponds to a right/a prerogative allocated to the owner of the tag.

In an embodiment, said electronic tag is stuck onto an external surface of said telephone item of equipment.

In an embodiment, provision is made for the tag to comprise anti-peeling means, for example of the VOID type (anti-peeling mechanism by deposition of letters VOID on the support from which the tag is unstuck and detection by reading these letters) or pre-scoring type (through the effect of the peeling force, the tag parts along the scoring provided).

In particular, to form said anti-peeling means, said tag comprises two layers on one side and on the other of an intermediate ply, termed an inlay, comprising communication means, designed so that unsticking of the tag renders said communication means inoperative. In particular, the unsticking gives rise to a separation of the two layers each carrying a part of the inlay and communication means.

Also, said tag can comprise at least one scoring designed so as to tear said tag under the loading exerted by an unsticking of the tag. The security against the peeling of the tag is then improved.

In particular, said tag comprises an electronic microchip (or microcircuit) and an antenna linked electrically to form wireless communication means, said scorings being designed so that said tearing separates the microchip electrically from the antenna.

In an embodiment, said authentication datum is generated on the basis of a first secret encryption key stored in said electronic tag.

Provision may also be made for the method to comprise a step of random or pseudo-random generation of a random number by said external item of equipment, a step of transmitting said random number to the electronic tag, and said authentication datum is generated on the basis of said random number transmitted.

In this case, provision may be made for the method to comprise a step of encrypting said random number at the level of the external item of equipment on the basis of a second secret encryption key, in which method said verification comprises the comparing of said authentication datum with said encrypted random number.

In particular, said electronic tag comprises a unique identification datum and said first and second secret encryption keys having been generated on the basis of said unique identification datum.

In an embodiment, the electronic tag and the external item of equipment comprise radiofrequency wireless communication means, in particular of range less than a meter, in particular less than 50 cm, especially, less than 20 cm. In the case of a short range, it is more difficult for a third party to intrude into the communication which is set up with wireless communication means. Thus, the shorter the range, the securer the transactions.

The short range also makes it possible to impose an intentional act on the user.

It is noted that the external item of equipment is commonly called a radiofrequency electronic tag reader.

In an embodiment, said communication means are designed to communicate with an electronic device according to the NFC (Near Field Communication) standard or ISO standard 14443 (ISO: International Standardization Organization).

In particular, the communication means comprise cryptographic means for allowing authentication of the electronic tag by said external item of equipment.

In an embodiment, said electronic tag comprises a secure processing unit, processor type. In particular, the securing of the processor can be in accordance with the common criteria (for example according to ISO standard 15408) customarily used in computing or be in accordance with an FIPS (“Federal Information Processing Standard”) standard.

The invention also deals with a method of accessing a service, comprising an authentication step as presented above and a step of accessing said service when said verification is positive.

The verification is positive when the authentication datum complies with an expected value, for example the authentication datum must be equal to the above encrypted random number.

In embodiments relevant to the invention, the external item of equipment generally drives access means, for example means demarcating this access, such as for example an access turnstile to a railroad network or to a theater.

The invention also deals with the securing of authentication by means of an electronic tag during access to a service (in particular for the provision of intangible goods), said electronic tag comprising cryptographic means for exchanging at least one authentication datum with an external item of access equipment. A securing method then comprises a step of sticking said electronic tag on a mobile telephone item of equipment so that said authentication requires the presence of said mobile telephone item of equipment.

As specified above, the sticking of the tag and the personal character of the mobile telephone item of equipment guarantee an improvement in security during authentication.

In an optional manner, the securing method can comprise steps and characteristics pertaining to those of the authentication method.

The invention is also aimed at a system for authenticating access to a service, comprising:
means for obtaining, in an electronic tag, at least one authentication datum by means of a cryptographic processing,
means for transmitting said at least one authentication datum from said electronic tag to an external item of equipment, the electronic tag and the external item of equipment being able to communicate with one another,
means for verifying said at least one authentication datum received by said external item of equipment,
a mobile telephone item of equipment,

in which system said electronic tag is stuck onto said mobile telephone item of equipment so that said transmissions between the electronic tag and the external item of equipment require the presence of said mobile telephone item of equipment.

The advantages of this system are comparable to the advantages afforded by the method according to the invention.

In an embodiment, said electronic tag can comprise anti-peeling means, in particular able to render communication means provided in the tag inoperative, in the event of peeling.

In an embodiment said tag comprises an inlay layer formed in part by communication means and a plurality of layers placed on one side and on the other of the inlay, said anti-peeling means comprising at least one set of said layers placed on one side and on the other of the inlay, the set being designed to tear under a loading exerted for unsticking said tag. Within the sense of the present invention, unsticking is understood to mean the action of an individual to unstick the tag from the mobile telephone item of equipment to which it is stuck.

In particular, said set is designed so that a first torn part of said set of layers remains stuck to said mobile telephone item of equipment and a second torn part is peeled from said mobile telephone item of equipment so as to render said communication means inoperative.

As an alternative or in combination, said anti-peeling means comprise at least one scoring provided on said electronic tag, said at least one scoring being designed so as to tear said tag under the loading exerted by an unsticking of the tag.

In particular, said tag comprises wireless communication means, said scorings being designed so that said tearing renders said communication means inoperative.

In a structural embodiment, the electronic tag comprises a plurality of superimposed layers and in which said anti-peeling means comprise a plurality of scorings on the various layers designed so as to tear said tag during the unsticking of the tag.

In particular, said tag comprises an electronic microchip and an antenna that are linked electrically to form wireless communication means, said scorings being designed so that the tearing separates the microchip electrically from the antenna.

Particularly, an inlay layer of said layers comprises the electronic microchip and the antenna, said scorings being designed solely, with respect to the inlay layer, on layers on the side of the adhesive layer stuck onto the mobile telephone. The scorings are thus not visible. Extra security is achieved.

According to a structural embodiment of the electronic tag, the latter comprises an adhesive layer designed to stick said electronic tag on the mobile telephone item of equipment and covered with a holographic layer comprising at least one visual security element, the holographic layer being covered with an adhesive layer bonding it to an inlay layer comprising at least one electronic component, said inlay layer being covered with a film comprising a visual element and a protective layer. The electronic component can in practice be the microchip and/or the antenna forming the radiofrequency module.

According to an alternative, the tag comprises an adhesive layer able to bond said electronic tag to a support and covered with an opaque layer, the opaque layer being covered with an adhesive layer bonding it to an inlay layer comprising at least one electronic component, said inlay layer being covered with a film comprising a visual element and with a protective layer.

According to a variant, the tag comprises an inlay layer comprising at least one electronic component and covered with a film comprising a visual element, and a security layer stuck to said inlay layer by an adhesive layer, said security layer comprising adhesive means exhibiting an adhesive strength with said mobile telephone item of equipment greater than the adhesive strength with said adhesive layer so that said security layer remains on said mobile telephone item of equipment when said tag is unstuck from said mobile telephone item of equipment.

According to another variant, the tag comprises an adhesive layer under an inlay layer comprising at least one electronic component, said adhesive layer being able to bond said electronic tag to a support and said inlay layer being covered with a film comprising a visual element and with a very thick protective layer.

In an optional manner, the authentication system can comprise means pertaining to the characteristics of the authentication and securing methods.

In particular, the electronic tag can comprise a unique identification datum on the basis of which the first and second secret encryption keys, used during the cryptographic processing, are generated.

In particular, the unique identification datum comprises a serial number of the electronic tag.

As a variant, the unique identification datum comprises a datum for identifying the mobile telephone item of equipment.

In particular, the unique identification datum comprises a datum for identifying the mobile telephone item of equipment in a mobile telephone network.

For example, the unique identification datum can comprise the International Mobile Equipment Identity or IMEI of the mobile telephone item of equipment in the mobile telephone network. This makes it possible to establish a direct bond between the electronic tag and the mobile telephone of the owner, for additional verificatory checks for example.

As an alternative, the unique identification datum comprises the international identity of the mobile subscriber (International Mobile Subscriber Identity or IMSI) of the mobile telephone item of equipment connecting to the mobile telephone network.

As a variant, the unique identification datum can comprise a MAC (Medium Access Control) address or IP (Internet Protocol) address in a computer network.

In another variant, said second item of information can comprise a conventional telephone number in a telephone network.

The invention exhibits practical applications in particular in the securing and protecting of confidential data, for example bank data, identification data for accessing services or premises.

The characteristics and advantages of the present invention will be more clearly apparent on reading a preferred embodiment illustrated by the appended drawings, in which:

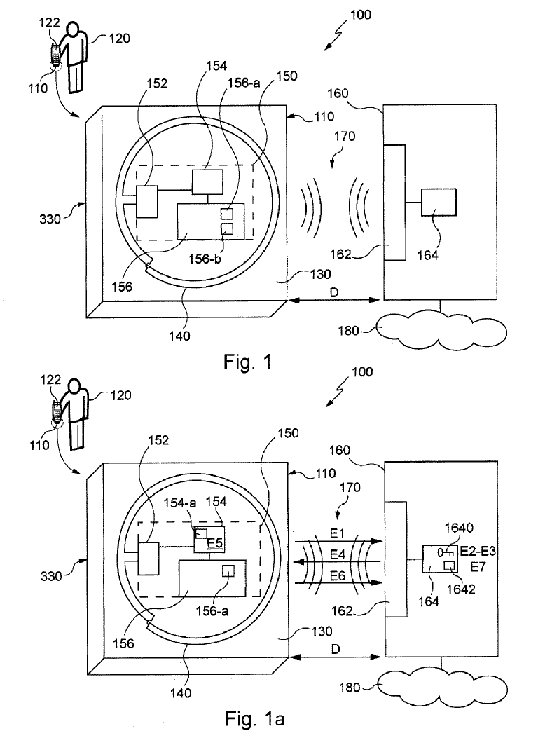

FIG. 1 illustrates an exemplary use of an electronic tag according to the invention;

FIG. 1a illustrates another exemplary use of an electronic tag according to the invention;

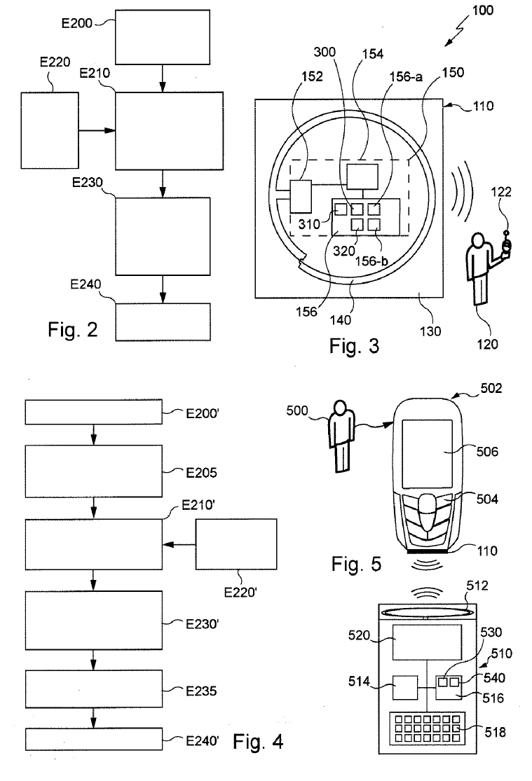

FIG. 2 is a chart representing the parametrization steps of the electronic tag of FIG. 1;

FIG. 3 illustrates an exemplary electronic tag implementing the present invention;

FIG. 4 is a chart representing the parametrization steps for the electronic tag of FIG. 3;

FIG. 5 schematically represents a first exemplary system for the implementation of the invention;

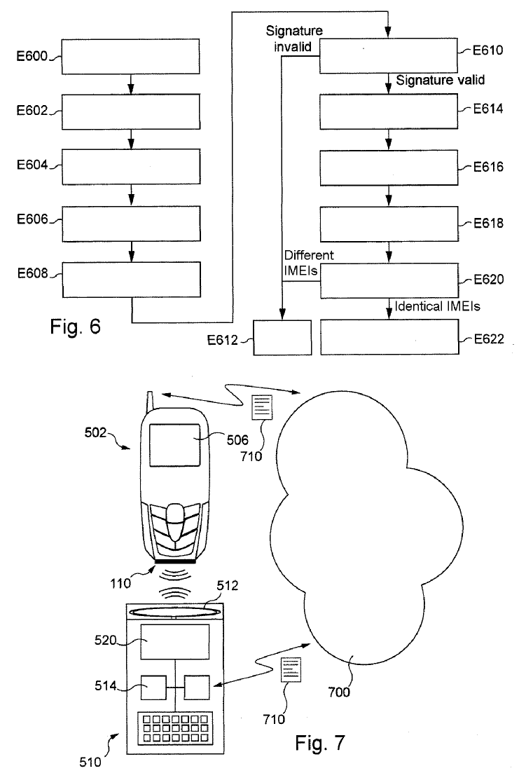

FIG. 6 is a chart representing the steps of authentication of the electronic tag by the system of FIG. 5;

FIG. 7 schematically represents a second exemplary system for the implementation of the invention;

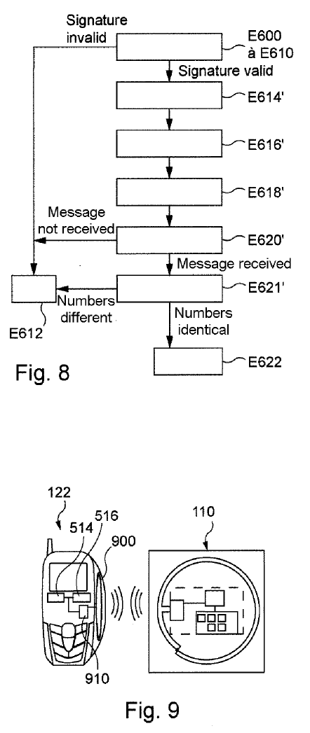

FIG. 8 is a chart representing the steps of authentication of the electronic tag by the system of FIG. 7;

FIG. 9 illustrates a link according to the invention between an electronic tag and a personal telephone;

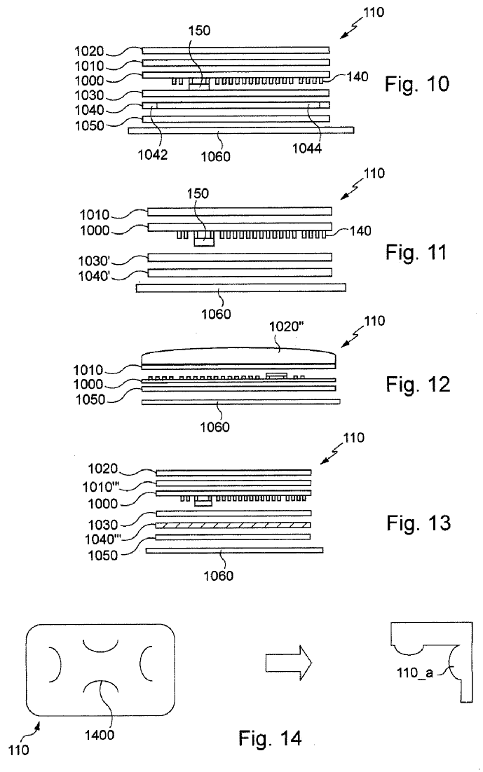

FIGS. 10 to 13 represent sectional views of several examples of electronic tag structures for the implementation of the invention; and

FIG. 14 illustrates an anti-peeling system of the electronic tags, implemented in an embodiment of the invention.

Although the invention is now described in part in conjunction with an application relating to a transport subscription and to the use of an RFID tag, the person skilled in the art would be able to transpose the invention to other fields of application, for example payment or identity, and to any type of electronic tag.

Represented schematically in FIG. 1 is a system 100 for the use of an RFID wireless access electronic tag 110 in an application tied to a transport subscription.

The RFID electronic tag 110 is personal to a subscriber 120 to a transport service who has stuck it onto his portable telephone 122 so as not to lose said tag.

A mobile telephone 122 comprises in particular a set of main components allowing conventional operation, and which include a means of authentication with a mobile telephone network (for example via a SIM card), an energy accumulation means capable of providing electrical energy to the other components of the telephone 122 for their operation, an entry means (for example a keypad), a display means (for example a screen), a means for exchanging voice and data via the mobile telephone network, a means of wireless communication with the mobile telephone network, in particular whose operating frequency is of the order of several hundred MHz.

The RFID electronic tag 110 comprises a plastic substrate 130 onto which are stuck an antenna 140 and a silicon-based microchip 150. The antenna 140 and the microchip 150 are linked by an input-output interface 152 internal to the microchip 150 to form a passive transponder, that is to say which uses the energy of a reader 160 to operate, short-range radiofrequency.

The RFID electronic tag is stuck onto the external casing of the telephone 122 by way of an adhesive layer 330. It is noted here that the mobile telephone 122 is personal to its owner 120, who in a conventional manner is not prompted to separate himself therefrom. The bond between the user 120 and his telephone 122 thus constitutes a level of security during authentication for access to the service provided by the electronic tag. The stronger the bond, the greater the security.

The microchip 150 comprises a microcontroller 154 for executing tasks such as the reception and transmission of data via the antenna 140 and/or execution of an application stored in an internal memory 156. The microcontroller 154, also called a processor, is advantageously made secure in accordance with a standard, for example relating to the common criteria CC (ISO standard 15408) or the FIPS standard. The microcontroller stores, in particular, information protected against illicit access and comprises cryptographic means.

The internal memory 156 comprises data relating to the subscription of the user 120 to the transport service: a unique identifier 156-a as well as a date of validity 156-b; as well as applications and data necessary for the operation of the services provided by the RFID electronic tag 110: software for driving the communications, digital data signature application, communications encryption application, cryptographic key used for encryption and/or signature.

It is understood that the subscription data can take diverse forms, for example the form of a program to be executed on the microcontroller 154.

For security reasons, it may sometimes be advantageous for these data relating to the user's subscription, especially if they are sensitive, to be stored actually inside the secure microcontroller 154.

With reference to FIG. 2, the parametrization or customization of an electronic tag for accessing the transport network, for example the electronic tag used in FIG. 1, comprises the subscription E200 of a subscriber 120 to a transport company by providing personal data. A unique subscriber number is then allocated to this new subscriber.

The company then registers E210, in the memory 156 of a virgin electronic access tag E220, the subscriber number and a limit date of validity.

It will be understood that, for an adaptation of the invention to, in particular, security criteria, the customization of the electronic tag is not limited to the simple registering of these two data below. Provision may in particular be made for the registering of cryptographic keys, of applications and of ad hoc data designed to allow authentication of the electronic tag with an external reader, by way of the RFID communication means.

The electronic access tag thus prepared is transmitted E230 to the subscriber 120 by post, who can then use E240 said electronic tag to access the transport network, in particular by reader gantries 160.

Returning to FIG. 1 to illustrate a mechanism E240 for using the RFID electronic tag 110, the subscriber 120 presents his telephone 122 with the tag 110 at a distance D of less than 1 meter from the reader gantry 160 for access to the metro.

At this distance, the electronic tag 110 detects the radiofrequency field 170 emitted by the antenna 162 of the gantry 160, the effect of which is to energize the passive microchip 150. It then manifests its presence to the gantry 160 by transmission of a radiofrequency message according to ISO standard 14443.

The microcontroller 164 of the gantry 160 then emits an interrogation request to the electronic tag in radiofrequency range.

In the case of FIG. 1, the microcontroller 154 receives and decodes the request of the gantry and returns, by radiofrequency, the identifier 156-a and the date of validity 156-b.

On receipt, the microcontroller 164 verifies the validity of these two items of information, for example by connecting to a remote server via a computer network 180, then authorizes access to the transport means, for example by releasing an access turnstile.

As an alternative, represented by FIG. 1a, a secure solution provides for the implementation of a cryptographic process for authenticating the owner 120 with the transport service 160. This solution comprises elements in common with that of FIG. 1, and for which care has been taken to use identical references.

In this alternative, the microcontroller 164 of the external reader holds a secret master key 1640 and customary cryptographic means 1642 implementing, for example, hash and/or encryption functions. It is possible to choose, for security reasons, a microcontroller 164 made secure according to the FIPS standard or in accordance with the common criteria. It is understood that additional means of cryptography, authentication and security of authentication can be used.

After establishment of the communication with the electronic tag 110, the external reader 160 requests the subscriber's unique subscriber number 156-a from the tag 110, which provides it in response (step E1). It is also possible to use any unique identification datum, such as for example a serial number of the tag 110 which is registered in the memory 156 of the electronic tag 110.

On the basis of this subscriber number received, of the master key 1640 and of the cryptographic means 1642, the microcontroller 164 calculates a secret key 154-a tied to the owner (step E2). This secret key will in particular have been generated previously by a secure electronic entity outside the electronic tag, transmitted to this tag by this exterior entity, and stored by the electronic tag 110 in the secure nonvolatile memory of its microcontroller 154. The prior registering and prior storage can in particular take place during the aforesaid step E210.

The microcontroller 164 thereafter generates a random, in particular pseudo-random, number NA and encrypts it with the aid of the secret key generated (step E3) to obtain a result R1.

Independently of the encryption, and preferably previously, the reader 160 sends to the tag 110 an authentication request (step E4) containing the random number.

On receipt of this request, the electronic tag 110 and its microcontroller 154 encrypts (step E5) the random number with the pre-stored secret key 154-a to obtain a result R2.

The tag 110 responds to the request E4 by providing the result R2 (step E6). The result R2 is in this case an authentication datum in the sense that, as will be seen subsequently, it authenticates the electronic tag 110.

The reader 160 receiving the value R2, compares it (step E7) with the value R1 calculated. In the event of positive comparison, the reader 160 affords access to the transport means. In the event of negative comparison, the reader 160 forbids access.

The processings described here as carried out by external readers 160 can be offloaded to a remote server of the network 180, in which case the means of the microcontroller 164 such as were described above are provided on the remote server.

With reference to FIG. 3, an exemplary electronic tag 110 for the implementation of the invention has been represented.

The RFID tag 110 is of similar type to those of FIGS. 1 and 1a, and therefore comprises elements in common with these tags and which will not be described again. Furthermore, the memory 156 comprises an identifier 300 corresponding to the IMEI number of the portable telephone of the subscriber 120, a private encryption key 310 of PKI (“Public Key Infrastructure”) type and an authentication program 320 which can be executed by the microcontroller 154.

The tag 110 is also provided, on one of its faces, with an adhesive layer 330 allowing the sticking of the tag 110 onto a support.

Various conceivable physical structures for the tag 110 will be described subsequently, for example to form a tag or a more or less rigid card.

With reference to FIG. 4, the customization of this tag 110 for the implementation of the invention comprises in a manner similar to step E200 of FIG. 2, the subscribing E200′ of the subscriber to the transport network. At this stage the subscriber furthermore provides the IMEI number 300 of his portable telephone 122.

The transport company, when it validates the subscription, can then optionally verify and/or retrieve if necessary from the subscriber's telephone operator whether this IMEI number 300 does indeed correspond to the subscriber 120, so as in particular to avoid any error liable to disable the operation of the tag.

The customization E210′ of a virgin RFID tag E220′ is then performed. The virgin RFID tag E220′ already stores a generic authentication program 320 which will be used by all the tags.

Customization E210′ comprises the storing in the memory 156 of the subscriber identifier 156-a, the date of validity 156-b, the validated IMEI number 300 and a private encryption key 310 generated by the transport company.

The customized RFID tag is then transmitted (E230′) to the subscriber 120.

The latter sticks (E235) the RFID tag 110 onto his portable telephone 122 with the aid of the adhesive layer 330. It will be possible to provide tag anti-peeling means as described subsequently.

Finally, the subscriber 120 can use (E240′) the RFID tag 110 for access to the transport network at the access reader gantries 160, as described above.

With reference to FIGS. 5 and 6, a first exemplary application according to the invention is now described, where a controller of the transport network wishes to verify the transport ticket of a traveler 500.

In accordance with step E235 above, the traveler has, previously, stuck the RFID tag 110 onto his portable telephone 502.

When requested by the controller, the traveler 500 presents (E600) his telephone 502 to the controller. The latter brings (E602) the telephone 502 to within a distance D of less than a meter from a portable reader 510.

The portable reader 510 is, just like the RFID tags, furnished with an antenna 512, a microcontroller 514 and an internal memory 516 making it possible to communicate by radiofrequency according to ISO standard 14443 or the NFC standard with the RFID tag 110 stuck to the telephone 502. A keypad 518 and a screen 520 that are linked to the microcontroller 514 constitute, for the controller, interfaces with the embedded system. The microcontroller 514 and the memory 516 are furthermore provided with any software necessary for the normal operation of the interfaces and other communication components.

The portable reader 510 also stores, in memory 516, the public encryption key 530 associated with the private key 310 of the RFID tag 110, and signature verification software 540.

When the RFID tag 110 is within range of the reader 510, it is energized by the radiofrequency field generated by the reader and then initiates an initialization process with the reader 510. A communication is then established (E604) between these two items of equipment.

The reader 510 thereafter emits (E606) an identifier request to the tag 110.

The microcontroller 154 interprets the request as asking for the IMEI identifier 300. It then forms a message comprising this identifier 300 retrieved in memory 156 and then signs the message formed with its private PKI key 310. The tag 110 thus responds (E608) to the request by the radiofrequency transmission of the signed message comprising the identifier 300.

Optionally, the message can be encrypted to increase security.

The reader 510 receives the signed message and verifies (E610) the latter's signature with the aid of the key 530. If necessary the microcontroller 514 decrypts the message.

In the event of an invalid signature, a message is displayed on the screen 520 and the controller is warned of a fraud and takes the appropriate measures (E612).

The public key 530 can be determined on the basis of a list of unique keys for all the tags stored in the memory 516 of the reader 510, the list associating with each subscriber number 156-a the corresponding public key 530. To find this key 530, the tag 110 can provide the number 156-a as plaintext, during step E608.

As a variant, this key 530 can be retrieved, on the basis of the subscriber number 156-a, from a remote server through a communication network to which the reader 510 is linked.

As a variant, the key 530 can be generated instantly on the item of equipment 510 by a cryptographic function applied to the number of the subscriber 156-a.

When the signature of the message is valid, the IMEI identifier 300 is displayed (E614) on the screen 520 of the reader 510.

In parallel, the controller retrieves, in step E616, the IMEI number of the telephone 522. This number is readily retrievable to any portable telephone by typing the combination “* # 0 6 #” on the keypad 504 of the telephone 502. The IMEI number is then displayed on the screen 506 of the telephone, in step E618.

In step E620, the controller then verifies that the IMEI identifiers displayed on the two screens 520 and 506 are identical.

In the event of identity, the transport ticket is considered to be valid (E622).

In the absence of identity, a fraud is detected and appropriate measures are taken (E612).

With reference to FIG. 7, a system for the implementation of a second embodiment of the invention has been schematically represented.

The telephone 502 and the portable reader 510 are similar to those of FIG. 5. The telephone 502 is in particular able to communicate at least, in reception, on a mobile telephone network 700.

The portable reader 510 also comprises means of communication (not represented), for example an embedded application associated with an embedded SIM card, with an identical communication network or one interconnected to the mobile telephone network 700. Represented in FIG. 7 is a single network 700 to which the two items of equipment 510 and 502 are linked.

The customization of the RFID tag 110 stuck onto the telephone 502 is also similar to that presented in conjunction with FIG. 4.

In this embodiment, the IMEI number of FIG. 4 is replaced with a subscriber's IMSI number. As a variant, it can be envisaged to combine the presence of the two numbers in the tag.

Thus, during step E210′, the IMSI number 300′ of the SIM card of the telephone 122 of the subscriber 120 is recorded in the memory 156 of the tag 110. It is recalled here that the IMSI number of a SIM card makes it possible to identify in a unique manner a subscriber on the mobile telephone network 700.

This IMSI number 300′ can be obtained from a telephone operator for example during step E205, on the basis of the conventional telephone number of the subscriber 120.

An alternative to the use of the IMSI number is the direct use of the conventional telephone number, which is unique within one and the same country.

Referring now to FIG. 8, during verification of the transport ticket by the controller, steps E600 to E612 are repeated except that the number returned by the RFID tag 110 tied to the mobile telephone 502 of the user 500 is now the IMSI number rather than the IMEI number.

The operative mode described hereinafter requires that the telephone 502 and reader 520 items of equipment be able to access a mobile telephone network.

In step E614′, the microcontroller 514 generates a random or quasi-random number that it displays on the screen 520.

In step E616′, the reader 510 forms, for example, a message of the SMS type (the abbreviation standing for “Short Message System”) 702 containing in the text body the random number generated and as recipient the IMSI number 300′ received.

The reader 510 thereafter transmits the SMS message 702 on the mobile telephone network 700, in step E618′.

In step E620′, the telephone 502 receives the SMS message 702. If this message does indeed originate from the reader 510, then the IMSI number 300′ is valid (does indeed correspond to that of the telephone associated with the tag) and the authentication is effective (E622).

Furthermore, a higher degree of verification can be obtained by displaying the body of the SMS message 702 received by the telephone 502 on the screen 506 of the telephone and by comparing (E621′) the number which is displayed on the screen 506 with the number displayed on the screen 520.

If the two numbers do not agree or if no message 700 is received within a reasonable lag, for example one to two minutes, then the authentication is not effective. There is fraud (E612).

The two embodiments presented above also apply to access to a service, for example access to the transport network such as illustrated by FIGS. 1 and 1a.

In this case, step E612 should be seen as a step forbidding access since the authentication by the second item of information is not validated.

Step E622 is, for its part, a step affording access to the service considered.

In order to increase the security of access to the service, a double authentication is envisaged, on the one hand, the authentication of the tag with the entity such as illustrated by FIGS. 5 to 8, and on the other hand, the authentication of the owner via the first item of information, here the subscriber number 156-a, such as illustrated by FIG. 1a.

In an embodiment illustrated by FIG. 9 and described now, a measure complementary to the sticking of the tag 110 onto the telephone 122 is proposed. It can in particular be applied with any one of the configurations represented by FIGS. 5 to 8.

According to this complementary measure, the mobile telephone 122 also comprises short-range radiofrequency communication means formed by an antenna 900, the microcontroller 514 and memory 516, and by an input-output interface 902 linking the antenna 900 to the microcontroller 514.

The link between the tag 110 and the telephone 122 is supplemented with the radiofrequency communication between these two entities.

The telephone 122 can emit in a periodic manner a message to update a register in the memory 156 of the tag 110. The register stores for example a date-stamping and time-stamping item of information.

As long as the tag 110 is linked with the telephone 122, the register is updated, for example every minute.

The execution of an application by the microcontroller 154 of the tag can then be conditioned on the presence, in the register, of a time-stamping item of information dating from less than five minutes ago for example. Otherwise the microcontroller is disabled until a new update or reinitialization.

In this way, the requirement for the owner 120 to keep his RFID tag 110 in proximity to his portable telephone, that is to say in practice with him, is strengthened.

RFID tag structures 110 conceivable for realizing the previous embodiments are now described.

With reference to FIG. 10, the tag 110 is formed on the basis of an inlay 1000.

The inlay 1000 is composed of a PET (Polyethylene Terephthalate) substrate of thickness 50 to 75 μm on which is imposed an antenna 140 made of copper, aluminum or screen-printed antenna 140 connected to an electronic microchip 150 of 4 or 5 mm² and 150 μm thick, via a “flip-chip” method.

The inlay 1000 thus formed is placed in a structure composed of various layers of plastic or other material and of adhesives. The microchip 150 is then protected by the lower adhesive layers which make it possible to ensure a compensation in the thickness.

The structure can be cut to the desired size and shape.

In more detail, the inlay 1000 is covered with an adhesive-coated vinyl film 1010 of thickness 100 μm on which a visual is screen-printed. This visual can comprise the subscriber number 156-a (which does not then have to be stored in memory 156) and/or any item of information making it possible to identify the transport network.

This screen-printed film 1010 is protected against abrasion over time by a coating or a transparent acetate film 1020.

The inlay 1000 on the microchip 150 and antenna 140 side is covered with an adhesive layer 1030 into which the microchip 150 is sunk to compensate for the thickness that the latter adds.

A holographic layer 1040 is thereafter deposited on the adhesive 1030. The hologram affords a visual security element in the tag 110. In order not to disturb the radiofrequency properties of the antenna 140, the holographic element 1042 is placed at the periphery of the tag 110 and not at the level of the antenna 140.

The layer 1040 comprises a black PET portion 1044 placed directly under the microchip 150 and/or the antenna 140 so as to render these elements non-visible. Security is thus increased.

The last layer 1050 is an acrylic or equivalent adhesive exhibiting very good adhesion properties.

As represented in FIG. 10, the tag 110 also exhibits a liner 1060 deposited on the last adhesive layer 1050. This liner 1060 is present on the tag 110 delivered to the subscriber during step E230′ of FIG. 2. During step E235, the subscriber removes the liner 1060 so as to be able to stick this tag onto his portable telephone 122. It is noted that the adhesive strength between the liner 1060 and the adhesive layer 1050 is less significant than the adhesive strength between this layer 1050 and the holographic layer 1040 so as to allow the liner 1060 to be removed without damage to the other layers of the tag 110.

The order of depositing the various layers can vary according to the manufacturing method used.

Presented with reference to FIG. 11 is a second exemplary RFID tag structure 110. The inlay 1000, screen-printed 1010 and liner 1060 layers are similar to those of FIG. 10.

The lower face of the inlay 1000 is covered with a transfer adhesive 1030′ making it possible to ensure compensation of the thickness of the microchip 150 and the integrity of the layer 1040′ with the inlay 1000 when delivering the tag 110 to the subscriber.

The layer 1040′ is of the VOID type that is to say a layer which in combination with the adhesive 1030′ leaves a trace on the backing support in the event of subsequent detachment. In practice, the trace consists of the deposition of white letters “VOID”.

Presented with reference to FIG. 12 is a third exemplary RFID tag structure 110 in which the inlay 1000, screen-printed 1010, adhesive 1050 and liner 1060 layers are similar to those of FIG. 10. It is noted however that the inlay layer 1000 is positioned with the microchip 150 and the antenna 140 on top.

A transparent polyurethane resin dome 1020″ with clean edges shrouds the sticker. This dome has a large thickness in relation to the other layers, typically 2 mm, and thus rigidities the structure. It mechanically protects the microchip 150 placed on top and the screen-printed layer 1010 against abrasion. In practice, a thickness greater than five times that of the microchip, in particular ten times, may be considered to be large enough to provide the desired mechanical protection.

Presented with reference to FIG. 13 is a fourth exemplary RFID tag structure 110 in which the inlay layer 1000, protection layer 1010, adhesive layers 1030 and 1050 and liner layer 1060 are similar to those of FIG. 10.

The layer 1010′″ is an acrylate layer composed of a white upper sub-layer and of a black lower sub-layer. This layer 1010′″ is customized by laser. The laser shot erodes the white sub-layer to reveal the black sub-layer. Very good contrast of the etched figure is thus obtained, in particular for a barcode. In addition, thermal or ink jet customization is also possible on this layer alone or in combination with laser customization.

The layer 1040′″ consists of a white PET which prevents visibility of the microchip 150 and of the antenna 140 from the underside of the tag 110.

These various tag structures 110 offer various levels of protection relating to anti-peeling, various levels of protection of the microchip 150 against repeated physical stresses due to the fact that the tag can be placed on a regularly used entity.

With reference to FIG. 14, whatever the exemplary RFID tag structure 110, it is possible to add scorings 1400 on the various layers of the structure so as to physically destroy the tag 110 in the event of detachment from its support: a part of the tag 110-a remains on the support and the other 110-b (not represented) is peeled off.

The scorings 1400 can in particular be placed so that during peeling the microchip 150 is separated from the antenna 140. This results in a tag 110 which is no longer functional after peeling.

It is chosen in particular that the scorings 1400 are not present on the printed vinyl or acrylate layers (1010, 1010′″) and varnish layers (1020, 1020″) so that these scorings 1400 are not readily detectable.

In an embodiment applicable to any one of the structures of FIGS. 10 to 13, provision may be made as a variant, in place of the scorings 1400, for all or some of the layers placed on one side (1010, 1020) or the other (1030, 1040, 1050) of the inlay 1000 to be “destructible”, that is to say that they tear under the loading exerted by the detachment of the tag 110 from its support.

Through this tearing, a part 110-a of these layers remains stuck to the backing support and the other part is easily detached, taking the microchip 150 and/or the antenna 140 with it so that the inlay is no longer functional and cannot be reused.

In these two anti-peeling embodiments, provision may also be made for the subscriber number 156-a to be deactivated from the transport system, in particular erased, upon peeling. In particular, the reader 510 of the controller or a system to which the reader has access can for example keep in memory an item of information about a measurement of a physical magnitude corresponding to the electronic tag 110, for example the impedance or the resistance, across the terminals of the antenna 140. Thus, the connection to the terminals of another antenna, typically in the event of peeling and impairment of the antenna 140, can be detected and a command deactivating access to the first item of information, here the subscriber number, can be performed.

Thus, the user will not be able to remove the RFID tag from his portable telephone, for example with the aim of allowing a third party to profit from his subscription, without difficulty or without destroying the tag.

The above examples are merely embodiments of the invention which is not limited thereto.

Other embodiments or modes of use can be envisaged. In particular, the authentication can be carried out to allow access or employment of a secret datum 156-a (stored for example in the memory of an electronic key), for example a private encryption key, in which case the whole of the verification process (FIG. 6) is advantageously implemented before authorizing or denying access to this secret datum.

1. Method of authentication during access to a service, characterized in that it comprises the following steps:
obtaining (ES), in an electronic tag (110), at least one authentication datum (R2) by means of a cryptographic processing,
transmitting (E6) said at least one authentication datum obtained (R2) from said electronic tag (110) to an external item of equipment (160), the electronic tag (110) and the external item of equipment (160) being able to communicate (E1, E4, E6) with one another,
verifying (E7) said at least one authentication datum (R2) received by said external item of equipment (160),
said electronic tag (110) being stuck onto a mobile telephone item of equipment (122, 502) so that said transmissions (E1, E4, E6) between the electronic tag (110) and the external item of equipment (160) require the presence of said mobile telephone item of equipment (122, 502).

2. Method according to claim 1, in which said electronic tag (110) is stuck onto an external surface of said mobile telephone item of equipment (122, 502).

3. Method according to claim 1, in which the electronic tag (110) comprises anti-peeling means.

4. Method according to claim 3, in which, to form said anti-peeling means, said tag comprises two layers on one side and on the other of an intermediate ply, termed an inlay, comprising communication means, designed so that unsticking of the tag renders said communication means inoperative.

5. Method according to claim 1, in which said tag (110) comprises at least one scoring (1400) designed so as to tear said tag under the loading exerted by an unsticking of the tag.

6. Method according to preceding claim 5, in which said tag (110) comprises an electronic microchip (150) and an antenna (140) linked electrically to form wireless communication means, said scorings (1400) being designed so that said tearing separates the microchip (150) electrically from the antenna (140).

7. Method according to claim 1, in which said authentication datum (R2) is generated on the basis of a first secret encryption key (154-a) stored in said electronic tag (110).

8. Method according to claim 1, in which the electronic tag (110) and the external item of equipment (160) comprise radiofrequency wireless communication means.

9. Method according to claim 8, in which the communication means are designed to communicate with said external reader (160) according to the NFC standard.

10. Method according to claim 9, in which the communication means comprise cryptographic means for allowing authentication of the electronic tag with said external reader.

11. Method for securing authentication by means of an electronic tag (110) during access to a service, said electronic tag (110) comprising cryptographic means for exchanging at least one authentication datum (154-a) with an external item of access equipment (160), the method comprising a step (E235) of sticking said electronic tag (110) on a mobile telephone item of equipment (122, 502) so that said authentication requires the presence of said mobile telephone item of equipment (122, 502).

12. System for authenticating access to a service, comprising:
means for obtaining, in an electronic tag (110), at least one authentication datum (R2) by means of a cryptographic processing,
means for transmitting said at least one authentication datum (R2) from said electronic tag (110) to an external item of equipment (160), the electronic tag (110) and the external item of equipment (160) being able to communicate (E1, E4, E6) with one another,
means for verifying said at least one authentication datum (R2) received by said external item of equipment (160),
a mobile telephone item of equipment (122, 502);
in which system said electronic tag (110) is stuck onto said mobile telephone item of equipment (122, 502) so that said transmissions (E1, E4, E6) between the electronic tag (110) and the external item of equipment (160) require the presence of said mobile telephone item of equipment (122, 502).

13. System according to preceding claim 12, in which said tag (110) comprises anti-peeling means and an inlay layer (1000), formed in part by communication means and a plurality of layers placed on one side (1010, 1010′″, 1020, 1020″) and on the other (1030, 1030′, 1040, 1040′, 1040′″, 1050) of the inlay (1000), said anti-peeling means comprising at least one set of said layers placed on one side and on the other of the inlay, the set being designed to tear under a loading exerted for unsticking said tag.

14. System according to claim 13, in which said set is designed so that a first torn part (110-a) of said set of layers remains stuck to said mobile telephone item of equipment and a second torn part (110-b) is peeled from said mobile telephone item of equipment so as to render said communication means inoperative.

15. System according to claim 12, in which said electronic tag (110) comprises first generating means able to generate an authentication datum (R2) on the basis of a first secret encryption key (154-a) stored in said electronic tag (110).
